(19) United States
(12) Patent Application Publication
(10) Pub. No.: US 2026/0315934 A1
(43) Pub. Date: Oct. 15, 2026

(54) SYSTEM AND METHODS FOR VIDEO GAME LEVEL CONTENT GENERATION

(71) Applicant: ELECTRONIC ARTS INC., Redwood City, CA (US)

(72) Inventors: IGOR BOROVIKOV, Foster City, CA (US); Jesse Hans Strokes Harder, Redwood City, CA (US); Fernando De Mesentier Silva, New York, NY (US)

(21) Appl. No.: 19/176,524

(22) Filed: Apr. 11, 2025

(51) Int. Cl. A63F 13/67

(52) U.S. Cl. CPC A63F 13/67

(57) ABSTRACT

Systems and methods are disclosed for generating and modifying video game levels. A machine learning agent is trained and configured to predict gameplay behavior as sequences of gameplay actions and game states. During gameplay, the agent generates state action sets, which are used to inform the creation or modification of a virtual environment. The system analyzes state action sets to determine what types of assets or environmental features are required to support the intended gameplay behavior. Game content—such as assets and environments—are then dynamically generated or selected for placement within the game level. Thereafter, playability verification can be performed by simulating agent traversal through the newly created environment. Furthermore, detected anomalies can trigger corrective updates to ensure the level remains functional and engaging.

### TECHNOLOGICAL FIELD

Example embodiments of the present disclosure relate to video game development, and more particularly, to content and game level generation systems.

### BACKGROUND

Content creation for video game levels is a valuable feature for expanding gameplay and increasing player engagement. However, the tooling required to support such creation—particularly user-generated or guided content—is often complex and resource-intensive. Existing methods frequently rely on manual adjustments or static rule sets, limiting scalability and adaptability. Accordingly, there is a need for automated systems and methods capable of generating or modifying game levels with minimal manual intervention.

### SUMMARY

The present disclosure provides for systems, methods, and non-transitory computer readable mediums that are configured to deploy an imitation learning agent into a gameplay session of a video game; receive a state action set generated by the imitation learning agent, the state action set comprising at least state data and a gameplay action; determine, based at least in part on the state action set, one or more level creation instructions corresponding to at least one of an asset placement or a topological modification; identify one or more assets based on the one or more level creation instructions; instantiate the one or more assets into a virtual interactive environment of the video game; identify, based at least in part on the one or more level creation instructions, a portion of a topological surface of the virtual interactive environment for modification; modify the identified portion of the topological surface based on the one or more level creation instructions; and update the virtual interactive environment of the gameplay session based on the instantiated asset or the modified topological surface.

Additionally, the disclosure further provides for validating a virtual interactive environment updated with new content by being configured to direct the imitation learning agent to simulate traversal through the updated virtual interactive environment; identify one or more anomalies based on the simulated traversal, the anomalies comprising at least one of an unreachable objective, an impassable region, or an unintended gameplay constraint; and regenerate one or more level creation instructions to modify the virtual interactive environment in response to the identified anomalies.

### BRIEF DESCRIPTION OF THE DRAWINGS

The disclosure will be more fully understood from the following detailed description taken in conjunction with the accompanying drawings, in which:

FIG. 1A illustrates an example embodiment of a computing device environment for using imitation learning (IL) agents in a virtual interactive environment of a video game.

FIG. 1B illustrates an example embodiment of a software environment for using the IL agent in a virtual interactive environment of a video game.

FIG. 2 illustrates an example embodiment of a system for deploying the IL agent in a virtual interactive environment of a video game for generating a game level.

FIG. 3A illustrates an example embodiment of a process for the training of an IL agent.

FIG. 3B illustrates an example embodiment of a process for the inference of an IL agent.

FIG. 4 illustrates an example embodiment of a gameplay where the IL agent is trained.

FIG. 5 illustrates an example embodiment of the gameplay where the IL agent is generating the game level.

FIG. 6 illustrates an example embodiment of the gameplay where the IL agent is validating the playability.

FIG. 7 illustrates an example embodiment of the resources within a computing device.

### DETAILED DESCRIPTION

The systems and methods described herein relate to the generation of game levels based on gameplay. For instance, game levels are virtual interactive environments of a video game that can be generated—in whole or in part—by using data from previous gameplay (e.g., sessions) to predict future gameplay scenarios for modifying a video game level accordingly. For simplicity, the generation of a video game level can, in some embodiments, refer to the selection, placement, and adjustments of game assets and/or topology (e.g., terrain, floor, and other environmental aspects of the like) within the game level. Accordingly, the systems and methods disclosed herein are generate content to create new virtual interactive environments (e.g., video game levels) or makes changes to existing virtual interactive environments, thereby streamlining content creation in video games.

The systems and methods use one or more machine learning models trained on the game data and/or gameplay of a video game, among other things. In some embodiments, a system includes one or more imitation learning (IL) agents trained to perform and/or predict gameplay. For instance, an IL agent can be trained to predict and/or generate state action sets when deployed among an instance of a gameplay of a video game (e.g., a game session). The state action sets generated by the IL agent during gameplay are then used to modify and/or generate content for the video game level—such as through asset selection, and/or placement among the virtual interactive environment comprising the level.

As used herein, the term “state data” refers to state of a video game during an instance of gameplay (e.g., a game session). As known to a person of ordinary skill in the art, state data can be represented as a structured dataset that details the state of one or more virtual elements, entities, objects, or characters of a video game, either in whole or in part.

In contrast, the term “state action set” refers a dataset that includes at least; (i) state data and (ii) one or more gameplay actions. In some embodiments, the data of a state action set can correspond to particular agent and/or location of a video game level. Additionally, a state action set can include multiple states and actions, and, in turn, correspond to one or more moments in gameplay. Additionally, state action sets can also be used as input for a machine learning model—such as during training and/or inference.

Moreover, a state action set refers to one or more predicted potential actions and/or states for a virtual character and/or virtual interactive environment of a video game. For example, a state action set corresponding to an agent may be represented as (agent_state: standing near vault-able ledge, action: vault_over_ledge). This set (or pair, since the set comprises a pair of data in this example) is indicative of potential gameplay actions that correspond to a potential gameplay environment. In turn, the state action set serves to predict and/or identify potential gameplay scenarios, thereby providing the disclosed system with an input for which to infer what kind of environment can be created or instantiated in order to support the potential gameplay scenario.

Accordingly, when an IL agent predicts or generates a state action set, it outputs a representation of what the agent intends to do in a particular local context (e.g., agent state=crouched, action=dash forward). This predicted state action set is then used by downstream systems—such as an environment sampling module or game asset module—to generate, select, and/or place a corresponding game asset among the video game level to support the predicted state action set (e.g., fill in the geometry of a game level to create a ledge to vault over). As such, state action sets are used to generate a level that remains semantically aligned with the IL agents predicted gameplay, which in turn is aligned with the gameplay of the video game data it is trained on.

### System Overview

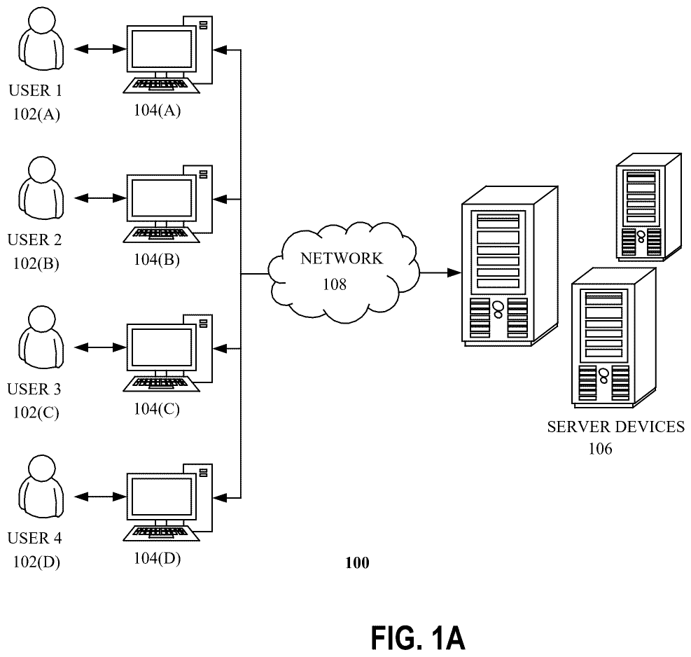

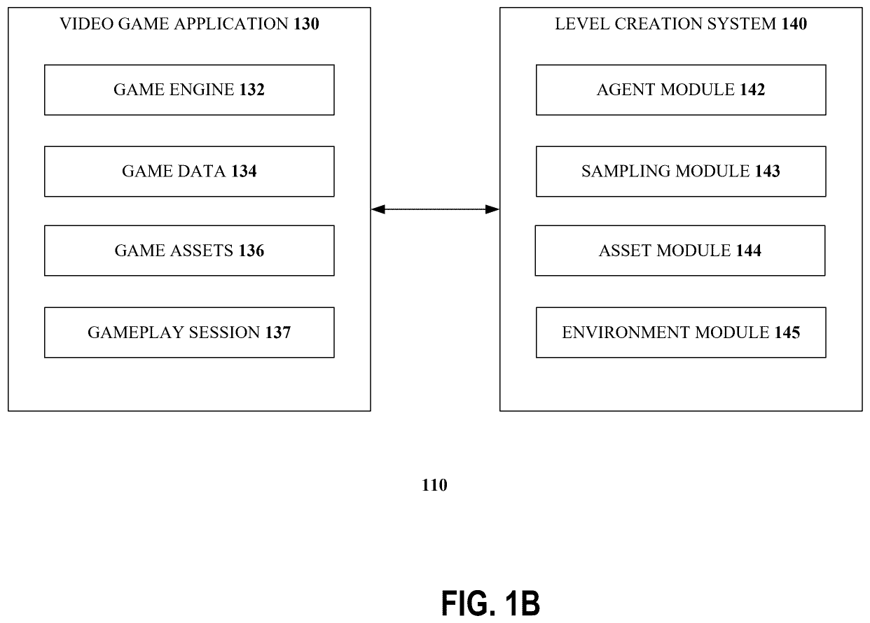

FIG. 1A illustrates an example embodiment of a system 100 for deploying imitation learning (IL) agents among a virtual interactive environment of a video game.

As shown, the system 100 is an environment including users 102(A), 102(B), 102(C), and 102(D) (collectively referred to herein as “users 102”) of respective computing devices 104(A), 104(B), 104(C), and 104(D) (collectively referred to herein as “computing devices 104). The computing devices 104 are communicatively coupled to server devices 106 over a network 108, for, among other things, playing a video game. It should be understood that the system 100 may include any number of users, computing devices, network and/or server devices beyond those shown in FIG. 1.

The users 102 may be players or automated learning agents playing the video game on the computing devices 104. In some embodiments, there is a one-to-one correspondence between the users 102 and the computing devices 104. In some embodiments, there is an N to one or one to N (wherein “N” is an arbitrary real value) correspondence between the users 102 and the computing devices 104. It should be understood that as described in the present disclosure, a “user” on, or of, a computing device playing a video game may refer to or be synonymous with a “player” or “agent” of the video game.

The computing devices 104 are hardware devices capable of or configured for, among other things, playing or executing the video game. As illustrated in the example embodiment of FIG. 1, the computing device 104(C) is a personal computer; and computing device 104(D) is a display device, though it should be understood that the computing devices 104 may be any type of computing device known to those of skill in the art. In some embodiments, the computing devices 104 have hardware components that may run the video game locally. In some embodiments, two or more of the computing devices 104 are similar to one another—e.g., of the same type. In some embodiments, the computing devices 104 may run or execute video games through a cloud gaming service, as known to those of skill in the art.

In some embodiments, computing devices 104 are used by the users 102 for gameplay of a video game. The gameplay of a video game can correspond to causing a virtual character to perform one or more gameplay actions. For example, gameplay can include jumping, shootings, opening doors, moving forward, moving backward, dodging, attacking, chasing, falling, rolling, and other gameplay actions of the like. In some embodiments, performing gameplay actions generates and/or changes state data of a video game during gameplay.

In some embodiments, the computing devices 104 connect to a gameplay session of the video game by way of being communicatively coupled to the server devices 106 over the network 108. In some embodiments, the network 108 communicatively couples the computing devices 104 and the server devices 106. In some embodiments, the network 108 may be any method of connectivity or communication between devices known in the arts, such as, but not limited to, a direct wired connection, Near Field Communication (NFC), Local Area Network (LAN), an internet connection, or other communication methods of the like.

In some embodiments, the server devices 106 may be one or more computing devices including processors, graphic processors, memory, storage, and networking capabilities. The computing devices of the server devices 106 may be communicatively coupled to the computing devices 104 over the network 108. The server devices 106 may be configured to pair with the video game played by the users 102 via the network 108, such as for multiplayer gameplay.

Additionally, computing devices of 104 and 106 can be configured to predict state action sets during gameplay of a video game. Further, the computing devices may generate a state corresponding to the predicted action in the gameplay of the video game. The computing devices may determine environmental elements corresponding to the generated state. Furthermore, the computing devices may generate the game level based on the determined environment elements corresponding to the generated state. The computing devices may be configured to generate and/or modify game levels in the video game played by the users. The computing devices may receive the set of actions performed in the gameplay and the set of states generated in response to the set of actions in the gameplay. Additionally, the computing devices may train the IL model based on the received set of actions performed in the gameplay and the set of states.

### Video Game Application

FIG. 1B illustrates an example of a software environment 110 for deploying and utilizing an IL agent (also referred to herein as IL model) in a virtual interactive environment of a video game. As shown, software environment 110 includes video game application 130 and level creation system (LCS) 140.

Video game application 130 includes data and software that comprise a video game. Video game application 130 provides gameplay and other interactive and/or social features to users (or players or agents) during runtime execution (e.g., during gameplay).

By way of example and not limitation, video game application 130 includes game data 134 and game engine 132. As known to a person of ordinary skill in the art, game engine 132 uses game data 134 (e.g., state data, render data, simulation data, audio data, and other data types of the like) and game assets 136 to generate game session 137 for gameplay.

Game data 134 includes state data, simulation data, rendering data, audio data, animation data, and other data of the like—including game code—used and/or produced by game engine 132 during gameplay of a game session. The term “game data” can be used interchangeably with “gameplay data”.

As such, in some embodiments, gameplay data 134 can refer to data corresponding to a game session 137, among other things. In some embodiments, gameplay data (134) produced during gameplay of game session 137 can include, or be, used at least in part to create state action sets. The gameplay data 134 may be versioned and/or stored periodically as a number of files within a memory device associated with video game application 134 or remotely on a server or service. Additionally, the gameplay data 134, or copies and/or portions thereof, can be stored, referenced, categorized, or bucketed into in one or more memory buffers. A buffer can be configured to capture particular data, or data types, corresponding to gameplay data 134, including state action sets.

Game assets 136 include virtual objects, textures, normal maps, topology maps, level maps, animation files, audio files, character models, font libraries, visual effects, and other digital assets of video games of the like. Accordingly, game assets 136 can be an asset library (e.g., among a data store of a respective computing device storing and executing video game application 130) that are used during runtime (e.g., gameplay) to instantiate instances of assets that compose a virtual interactive environment.

Game session 137 is an instance of gameplay produced by game engine 132 based at least in part on game data 134 and/or game assets 136. For example, executing video game application 130 can cause an instance of gameplay to be generated. Each instance can be referred to as a “game session” or “gameplay session”. The game session can be made up of or include one or more virtual interactive environments. A virtual interactive environment can be or include one or more virtual levels, virtual social spaces, and/or graphical user interfaces that can be interacted with or in, for gameplay or socializing. As such, a game session can include, host, or enable—for users—participation and interaction by or with player characters, non-player characters, quests, objectives, and other features, elements, assets, objects, or other in-game entities of the like as known to those of ordinary skill in the art.

Gameplay session 137 may include virtual levels, spaces, objects and/or graphical user interface elements, among other aspects, of the video game application 134 that provide a playable or interactive virtual space (e.g., a virtual interactive environment) for a user or agent to play among, or to test, explore, navigate, and/or validate one or more aspects of. For instance, gameplay session 137 may be a level of a video game including quests, objectives, enemies, and other gameplay features, elements, or aspects known in the art. In some embodiments, gameplay session 137 may vary or differ between instances. In one example, a gameplay session may be of a first version of a first virtual interactive environment, while a subsequent instance of a gameplay session may be of a subsequent version of the first virtual interactive environment, such that there are changes or differences among the first virtual interactive environment between the two instances of the gameplay session.

Accordingly, gameplay session 137 provides an instance of gameplay to deploy one or more IL agents among. As known to a person of ordinary skill in the art, an IL agent (hereinafter “agent” in short) can refer to controllable character models configured to facilitate or perform gameplay actions or commands. In some embodiments, an IL agent and/or user may control and/or direct player characters in a virtual interactive environment among gameplay session 137. Additionally, a objects of gameplay session 128 may refer to controllable objects, or models, used to facilitate or enable gameplay or other in-game actions. Player objects may be, for example, vehicles, vessels, aircraft, ships, tiles, cards, dice, pawns, and other in-game items of the like known to those of skill in the art. In some embodiments, an IL agent and/or user can control or direct player objects in gameplay session 137, including, in some instances, by controlling player characters which in turn causes the objects to be controlled.

### Level Creation System (LCS)

Level creation system 140 (“LCS”) is software configured to generate a game level, in whole or in part based on state action sets generated by an IL agent during gameplay of video game application 130. As shown, LCS 140 include submodules 141 through 145 configured to generate content for game levels. In some embodiments, LCS 140 is a system of video game application 130. In other embodiments, LCS 140 is a system and/or service that is external to, and works in conjunction with, video game application 130; such as a service among a server device. In some embodiments, one or more modules of LCS 140 are configured to receive game data, including state data and state action sets, during gameplay of video game application 130. In some embodiments, modules of LCS 140 can send, or make available, data to other modules. For simplicity, the term “content” is used in short to refer to “game content”, which can include game levels in some embodiments.

### Agent Module

Agent module 142 is configured to deploy, direct, and manage an imitation learning (IL) agent (hereinafter “agent” in short) among game session 137 of video game application 130. In some embodiments, agents can be configured in or more forms for use within video game application 130, thereby providing flexibility and adaptiveness to the approach to multi-character interaction testing. In some embodiments, an agent may be as a virtual character—such as a player character or non-player character (NPC)—which can have a predefined, configurable, or procedurally generated character model and/or animations. In these cases, an agent functions as their own independent virtual characters—hereinafter referred to as “agent virtual characters”.

In other embodiments, an agent does not exist as a standalone virtual character but instead functions as a virtual control entity that becomes associated with, or to, an existing virtual character of the video game—hereinafter referred to as “agent associated characters”. In either form, agent module 142 can use the agent to navigate the virtual environment, interact with objects and other characters, execute gameplay actions, and generating state action sets. Accordingly, agents effectively operate like a player or user that provides instructions or input for controlling and/or directing an assigned in-game character.

When an agent is associated with a virtual character of a video game—such as player character or non-player character (NPC)—the agent acts as a decision-making and behavior control system, instructing the character on which tasks to perform, how to navigate among a virtual interactive environment, and when to engage in cooperative, competitive, or adversarial interactions, among other things. This approach is beneficial as it provides an approach for automated agent gameplay without disrupting the native framework of the game engine or logic. Moreover, this approach eliminates the need to instantiate additional virtual characters in a game session, thereby reducing computational costs. In some embodiments, the association between an agent and an in-game virtual character may be persistent throughout a gameplay session, while in others, the association may be temporary, allowing agents to take control of different characters as needed to facilitate testing objectives. In other embodiments, agent module 142 can deploy both forms of agents (agent virtual characters and agent associated characters) among a video game.

When deployed, agents can operate collectively and/or independently, providing a dynamic approach to game content and/or game level generation by constructing unique gameplay environments from predicted or generated state action sets. The state action sets generated by agents correspond to potential and/or future gameplay scenarios (e.g., actions and assets). For simplicity, a state action set created by an agent that includes a “pair” of data can be referred to as a “state action pair”.

In addition, agents remain centrally managed by agent module 142 to ensure that their actions and/or gameplay align with one or more gameplay testing strategies. Accordingly, agent module 142 and/or agent system module can override or modify an agent's current gameplay actions at any time during gameplay, such as pause gameplay and/or redirect an agent with more optimal actions. This centralized control allows for more granular coordination among multiple agents, ensuring that individual agent decisions contribute to a larger, structured multi-agent game content and/or game level generation approach while maintaining adaptability at both the system and agent levels.

The agent is trained to predict gameplay behavior based on sequences of state-action pairs observed during gameplay. Each state-action pair includes a representation of an agent's potential location or context (e.g., crouching behind cover) and potential gameplay action (e.g., vault over wall). The IL agent is trained using historical gameplay trajectories to map states to appropriate actions for generating potential states and actions among a state action set, such that they can be used to guide game content and/or game level generation processes.

During execution, the agent module receives gameplay data and continually improves the IL model based on collected state-action pairs. These pairs may be generated from player-controlled gameplay or scripted agent behavior. Once deployed, the IL agent uses its learned policy to infer the most likely next action from its current state.

The agent module may also generate the corresponding state, thus forming a complete state-action pair. Upon generating the pair, the agent module may simulate the predicted outcome by directing a virtual character associated with the agent to perform the corresponding gameplay action.

Each state-action set implies an expected interaction with the game environment, such as vaulting over an object, engaging a target, or navigating around an obstacle. These predictions inform subsequent systems in generating new gameplay content, including the placement of assets and adjustment of the game level topology.

### Sampling Module

Sampling module 143 is configured to receive a state-action set from the agent module to determine one or more modifications or changes to a virtual interactive environment corresponding to gameplay session 137. In some embodiments, sampling module 143 determines one or more assets to place and/or remove from a virtual interactive environment. In other embodiments, sampling module 143 determines one or more environmental changes (e.g., topology or terrain changes) to make to a virtual interactive environment.

Accordingly, sampling module 143 analyzes the state-action set to determine one or more the semantic and spatial requirements suitable to meet the gameplay conditions required among a virtual interactive environment for a virtual character to perform. As a result of this determination, the sampling module can generates one or more level creation instructions for other modules of LCS 140, such asset module 144 and environment module 145 as input for their respective game content and/or game level creation and/or generation processes. These level creation instructions may specify a category of asset (e.g., crate, enemy NPC, health pickup), a required topological condition (e.g., gap, ledge, ramp), or a spatial directive (e.g., place object three meters ahead of the agent) that correspond to one or more locations among the virtual interactive environment of game session 137. In some embodiments, level creation instructions are created from deterministic logic, including heuristics or rule-based logic, among other things.

Additionally, level creation instructions can be generated by a machine learning model—such as a large language module (LLM)—of sampling module 143 that is trained on game data 134 of video game 130 to make it capable of contextual inference based on gameplay history and spatial configuration. As an illustrative example, an LLM architecture for use among sampling module 143 can include a transformer-based neural network trained on structured and/or unstructured game data, among other things, such as images and/or videos of gameplay of video game application 130. In some embodiments, an LLM architecture includes an encoder and/or decoder configuration where input embeddings represent state-action tokens, environment metadata, and spatial context, among other things. The LLM can also include attention mechanisms to capture dependencies between gameplay behavior and environmental affordances, enabling it to generate context-sensitive modifications and/or content for game levels. Additionally, fine-tuning of the LLM can be based at least in part on curated datasets of level design annotations, scripted game logic, and historical gameplay traces that correspond to video game application 130 to further align output with game-level configurations that are cohesive to the atmosphere, design, and/or aesthetic of the video game.

Additionally, the LLM can be trained to generate structured level creation instructions that include data such as asset type, placement coordinates, or terrain modifications, conditioned on the state-action input. In some embodiments, the generated level creation instructions output by the LLM of sample module 143 can include natural language and/or structured machine-readable data. Accordingly, level creation instructions can be formatted as structured JSON, key-value pairs, or natural language descriptions depending on integration requirements.

As a non-limiting illustrative example, an agent of agent module 142 generates a set action set where the agent is to (i) crouch behind cover and (ii) vault over it. Accordingly, the LLM is configured to output level creation instructions that include at least a topological modification (adding a ledge suitable for vaulting) and/or an asset placement instruction (a low wall cover object behind the agent to justify the crouched state). Accordingly, a natural language-based output of the LLM for level creation instructions is illustrated below:
“Add a vault-able ledge 2.5 meters in front of the agent. Place a low wall behind the agent to justify the crouched cover position. Ensure the ledge is approximately 1 meter high and spans 2 meters in width.”

Alternatively, the LLM of sampling module can provide the same output above a structured machine-readable data, such as the example below:

```
“state_action”: {
  “agent_state”: “crouching_behind_cover”,
  “action”: “vault_forward”
},
“level_creation_instructions”: {
  “type”: “topology_change”,
  “description”: “Insert vaultable ledge in front of agent”,
  “geometry”: {
    “shape”: “ledge”,
    “height”: 1.0,
    “width”: 2.0,
    “depth”: 0.5
  },
  “location”: {
    “reference”: “agent_position”,
    “offset”: {
    “x”: 2.5,
    “y”: 0.0,
    “z”: 0.0
    }
  {
  “type”: “asset_spawn”,
  “category”: “object”,
  “asset_tag”: “low_wall_cover”,
  “placement”: {
    “reference”: “agent_position”,
    “offset”: {
    “x”: −1.0,
    “y”: 0.0,
    “z”: 0.0
    },
    “rotation”: 180
  }
```

### Asset Module

Asset module 144 is configured to receive level creation instructions from sampling module 143. Each instruction may specify an asset category or type and may include an indication of associated gameplay action or affordance (e.g., “vault-able object” or “explosive crate”). The asset module accesses game assets 136—e.g., among a corresponding data store of a computing device associated with video game application 130 and/or LCS 140—to identify and/or determine which assets are suitable for use in satisfying or fulfilling the level creation instructions.

In some embodiments, game assets are annotated with metadata that are used for searching and/or queries. Accordingly, asset module 144 queries game assets 136 (or a corresponding data store) to identify one or more assets whose metadata matches the specified instruction parameters. This metadata may include natural language-based tags of gameplay behavior descriptors, dimensional attributes, interaction types, and other terms of the like. For example, metadata can be or include “low_wall_cover”, “crate_heavy”, or “pickup_health”.

Upon identifying a suitable asset, the asset module instantiates the asset into the virtual interactive environment at a location specified among the level creation instructions. Alternatively, the asset module can, if unspecified among level creation instructions, instantiate an asset at location proximate to the agent. The instantiated asset is thereby contextually relevant to the agent's predicted action and spatially compatible with the topology of the surrounding environment.

This process ensures that the asset fulfills the gameplay semantics implied by the state-action set and preserves functional cohesion across dynamically generated or modified level content.

### Environment Module

Environment module 145 is configured to receive level creation instructions from sampling module 143, including those specifying topological modifications to a virtual interactive environment of gameplay session 137. These modifications can include adjusting terrain elevation, inserting ramps, depressions, gaps, or inclines, and reshaping surface geometry to support the spatial and physical affordances implied by a state-action pair. For instance, when a predicted gameplay action involves a vault maneuver, the environment module may create a raised terrain segment or ledge geometry at a specified offset from the agent's position. In some embodiments, the environment module performs such modifications by directly manipulating terrain or ground meshes at one or more locations among the virtual interactive environment using geometric, spatial, and/or location parameters included in the level creation instruction.

As used herein, a mesh refers to a geometric representation of a surface or object, typically composed of interconnected vertices, edges, and polygonal faces (e.g., triangles or quads) that define its shape and structure in three-dimensional space. In video games, topological features of a virtual environment—such as terrain, walkable surfaces, and navigable ground—are commonly implemented and represented as meshes. These meshes serve both a visual function (e.g., how terrain appears) and a physical function (e.g., how characters interact with the surface for movement or collision).

In some embodiments, environment module 145 may use mesh refinement techniques to make topological modifications including uniform mesh subdivision and vertex displacement. For example, the module may subdivide an existing terrain mesh to increase local polygon density in a target area and then apply vertex displacement based on either explicit shape parameters (e.g., height, slope, width) or gradient values derived from procedural rules. In some embodiments, the environment module may also use heightmaps or normal maps to inform the displacement process, enabling nuanced adjustments that maintain surface continuity. In addition to visual fidelity, the collision mesh corresponding to the terrain is concurrently updated to reflect the modified topology, ensuring physical interaction fidelity for virtual characters or other gameplay entities. This may include generating a new collision mesh segment using the subdivided topology and displacing vertices based on the modified surface profile.

In certain implementations, the environment module also applies terrain smoothing, anchoring, and transition operations to ensure that newly created topological features integrate cohesively with surrounding areas. For instance, when raising a terrain segment to create a platform, the environment module may flatten adjacent polygons to reduce steep or inaccessible slopes. Likewise, the module may resolve surface irregularities beneath previously placed assets (e.g., crates, props) to ensure stable grounding and navigability. These processes ensure that topological changes remain gameplay-aware, visually plausible, and structurally compatible with other modifications introduced by LCS 140.

In some embodiments, the environment module is further configured to identify a portion of a topological surface—such as a region proximate to the agent or specified by a coordinate offset—prior to applying a mesh-based modification. The identification may be based on spatial directives, predicted gameplay paths, or defined placement constraints included in the level creation instructions.

### Example System Architecture

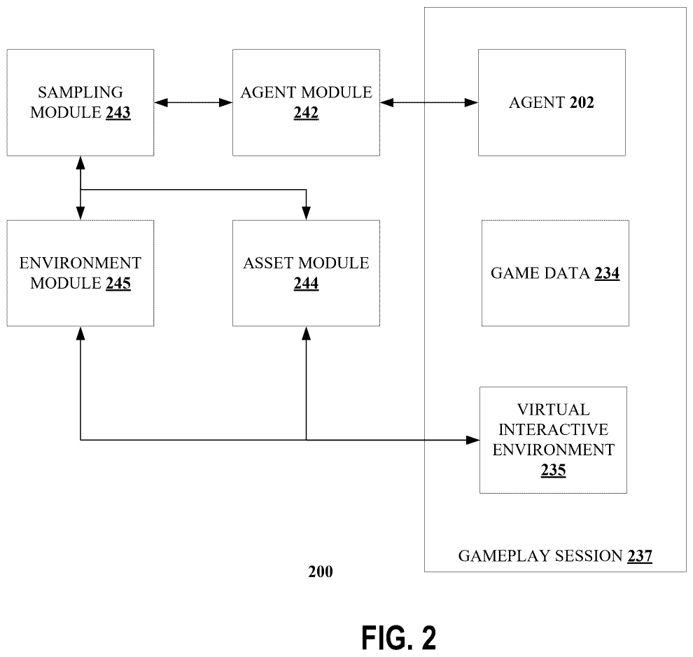

FIG. 2 illustrates an example embodiment of a system 200 configured for dynamic level content and/or game level generation based on predictive agent behavior. As shown, system 200 includes a plurality of modules—agent module 242, sampling module 243, asset module 244, and environment module 245—which function collectively as a Level Creation System (LCS). These modules operate independently from, but in conjunction with, components of an active gameplay session 237, which includes an executing agent 202, game data 234, and a virtual interactive environment 235. In some embodiments, system 200 corresponds to video game application 130 and LCS 140 of FIG. 1B.

Agent module 242 is configured to deploy and direct agent 202, which may be an IL agent configured to generate state action sets during gameplay session 237. Accordingly, agent 202 observes its local gameplay context and generates a state-action sets, where the state represents a compact snapshot of the agent's current conditions (e.g., position, posture, equipment state) and the action represents the next intended gameplay behavior (e.g., jump, vault, take cover). These predictions are generated based on an IL model trained using historical gameplay data and can be used to simulate or infer the agent's likely trajectory through the environment. In some embodiments, one or more agents 202 are deployed among game session 237 to provide for multi-agent based level creation.

In some embodiments, the imitation learning (IL) agent may be configured to periodically generate and transmit state action sets during the course of gameplay. The frequency or cadence of this generation may be configurable and based on one or more criteria, such as elapsed time intervals or thresholds of movement through the virtual interactive environment. For example, the agent may emit a new state action set every two seconds or after traversing a defined distance or region within a level. This periodic generation can be used to produce a stream of state action sets reflecting the evolving local context of the agent, which may then be processed by downstream modules for dynamic level modification, content adaptation, or gameplay analysis.

In another embodiment, the IL agent may be configured to generate and transmit state action sets continuously or semi-continuously in association with each gameplay action the agent intends to perform. In this configuration, every action decision made by the agent is accompanied by a corresponding state action set that captures the agent's local state and the intended behavior. This form of output may be particularly useful in real-time content and/or game level generation systems or in environments where fine-grained control over environment modification is needed.

In a separate embodiment, the IL agent may be deployed in an exploratory or task-based gameplay mode in which it is not required to generate state action sets. Instead, the agent may be directed to freely traverse the virtual interactive environment or attempt to complete one or more predefined gameplay objectives. In these scenarios, the agent may serve as a validation or testing entity and may be configured to generate debugging reports if it encounters an impassable region, unreachable objective, or other gameplay barrier. These debugging reports may include spatial context, attempted actions, and failure conditions, and may be provided to the agent module or other components of the level creation system for analysis and corrective action.

Sampling module 243 receives the state-action pair from agent module 242 and analyzes the gameplay context to determine which environmental features are semantically and spatially required to support the intended behavior. Sampling module 243 generates one or more level creation instructions, each of which may correspond to a topological modification (e.g., ledge placement, terrain shaping) or an asset-level insertion (e.g., an interactive object, NPC, or obstacle). In some embodiments, sampling module 243 performs this analysis using a trained machine learning model, such as a large language model (LLM), to align gameplay semantics with level design patterns.

Asset module 244 receives level creation instructions that correspond to asset placement operations. The module queries or accesses game data 234, which includes a data store of annotated game assets, to identify one or more suitable candidate assets. These assets are selected based on metadata such as gameplay affordance tags, dimensional properties, or aesthetic themes. Once identified, the asset module 244 instantiates the asset into the virtual interactive environment 235 at a position specified in the level creation instruction.

Environment module 245 is configured to handle topological modifications based on level creation instructions that specify changes to terrain or surface geometry. These modifications are implemented by altering one or more meshes corresponding to the terrain layer of the virtual interactive environment. In some embodiments, the environment module performs uniform mesh subdivision and vertex displacement to generate new topological features (e.g., ramps, inclines, gaps) or to modify existing ones. The corresponding collision mesh is also updated to reflect the modified physical boundaries of the terrain, ensuring compatibility with game physics and navigability constraints.

The virtual interactive environment 235 is the in-game space in which agents operate and where dynamic modifications are applied. Changes from the asset module 244 and environment module 245 are integrated into this environment during the course of gameplay session 237, supporting adaptive and behavior-aligned level generation.

Game data 234 can includes data or information about or corresponding to: (i) player characters, (ii) virtual objects, (iii) gameplay objectives, (iv) regions and areas of the virtual interactive environment, (v) gameplay events and triggers, (vi) and other game data of a video game. In some embodiments, gameplay data 234 includes data corresponding to the positions, paths, routes, regions, areas, and actions that agent 202 traversed, explored to, and/or performed in a virtual interactive environment. Additionally, game data 234 can be communicated between a video game application and the IL agent 202. Game data 234 can be used in part by IL agent 202 in a virtual interactive environment. An update to IL agent 202 can also be based in part on the game data 234.

In some embodiments, system 200 supports recursive improvement of the imitation learning agent over time. As agent 202 interacts with the dynamically generated environment, its actions and resulting environmental outcomes can be captured and stored to game data 234 as new state-action trajectories. These new samples can be used for post-session fine-tuning of the IL model managed by agent module 242, allowing the model to iteratively improve its policy based on exposure to newly generated and increasingly diverse level configurations. In this way, system 200 supports a continuous learning loop in which predictive agent behavior and level generation evolve together.

In some embodiments, an imitation learning (IL) agent—such as agent 202 managed by agent module 242—is configured to generate or influence game-level content during a gameplay session based on predicted player behavior. The IL agent may be trained using a dataset of historical gameplay, including state transitions and associated player actions. During deployment, the IL agent observes its current context within a virtual interactive environment and predicts a future action, optionally generating a corresponding game state as a result of that action. These state action sets can be used to guide automated content and/or game level generation, including modifications to terrain and the placement of interactive elements.

Agent module 242 may be configured to communicate state action sets to sampling module 243, which determines one or more semantic or spatial requirements necessary to support the predicted behavior. Sampling module 243 may refine the state action set to ensure it is valid and plausible within the constraints of the current environment. For example, if the predicted action is a jump, but no suitable landing surface exists, the sampling module may adjust the scenario to insert an appropriate topological feature, such as a platform or ledge. The sampling module may then generate one or more level creation instructions corresponding to either asset placement or topological modification, depending on the nature of the prediction.

In some embodiments, the IL agent may be configured to refrain from generating or transmitting state action sets within one or more designated regions or portions of the virtual interactive environment. These areas may be predefined by a designer, procedurally marked, or dynamically set during gameplay. The purpose of such configuration may be to preserve specific segments of the environment from being altered or regenerated by the level creation system. For example, a narrative-critical location, a designer-authored scene, or a previously validated gameplay segment may be marked as static or non-editable. When the agent traverses or operates within such regions, it may continue executing gameplay actions, but will be restricted from emitting state action sets, thereby preventing any associated environment modifications or asset placements during its presence in those areas.

In some examples, sampling module 243 distributes refined level creation instructions to asset module 244, which is responsible for querying available game data 234 to identify suitable game assets—such as objects, props, NPCs, or interactive elements—that fulfill the desired gameplay function. Asset module 244 selects and places these assets within the virtual interactive environment 235 in a manner that is consistent with the predicted gameplay behavior and the environment's spatial constraints.

Alternatively, or in combination, sampling module 243 may transmit topological instructions to environment module 245. In response, the environment module may modify mesh-based terrain using processes such as uniform mesh subdivision and vertex displacement, enabling the generation of ramps, gaps, or raised platforms. A corresponding collision mesh may also be generated or updated to ensure that the new topology behaves as expected with respect to physics and navigability. In this way, the gameplay environment adapts based on the anticipated behavior of the agent, enhancing interactivity and immersion. In some embodiments, noise or instability in the IL agent's prediction output may be filtered prior to instruction generation. For instance, a filtering process may be applied to smooth out erratic fluctuations in position or action prediction, ensuring stable environmental responses and reducing the risk of incoherent level changes.

In some embodiments, the sampling module may be provided with one or more supplementary instructions identifying specific regions or portions of the virtual interactive environment for which content should not be generated or modified. These instructions may be provided by a level designer, a procedural constraint engine, or another system component, and may include spatial coordinates, zone identifiers, or environment tags. Upon receiving a state action set from the agent that corresponds to a restricted or excluded area, the sampling module may be configured to disregard the state action set or suppress the generation of level creation instructions for that region. This functionality allows for selective preservation of designer-defined content, stability in critical narrative areas, or isolation of experimental generation to particular regions of the environment.

The gameplay session may also function as a data generation source for recursive model training. The outcomes of the agent's predictions—including which environmental modifications were triggered and how they affected gameplay progression—can be captured as updated gameplay data 234. This new data may then be used to further fine-tune or retrain the IL agent, enabling the system to continuously improve its behavior alignment, semantic understanding, and scenario generation accuracy over time.

Once trained, the IL agent predicts future actions the user is likely to take based on the current state of the game. Upon predicting the next action, the IL agent generates an appropriate game state that corresponds to this action and incorporates environmental elements that align with the game's mechanics and narrative. For example, the IL agent might predict that the player will perform an action such as jumping, which would generate a new state where the player's character is mid-air, with terrain elements dynamically adjusting to reflect this movement.

In some embodiments, if gameplay anomalies occur—such as when progression is blocked, or actions result in unplayable outcomes—agent module 242 may be re-engaged to generate a new set of predictions aimed at correcting or adapting the game state. Sampling module 243 may then evaluate these new predictions to generate corrective instructions. These instructions may result in the placement of assistive platforms, the relocation of obstacles, or the spawning of new game elements to enable successful progression.

In some embodiments, an imitation learning agent may be directed to perform exploratory traversal or gameplay interaction to validate the functionality of a newly generated or modified virtual interactive environment. If the agent is unable to reach an intended objective, traverse a region, or complete a gameplay task, this may be interpreted as an indication of an anomaly within the environment. The agent may communicate the failure condition to the agent module, which in turn generates a debugging report. The debugging report includes information about the context of the anomaly, including the agent's state, location, and failed action. This debugging report may be transmitted to the sampling module, which is configured to ingest the debugging report and generate one or more level creation instructions that target the anomalous region. The instructions may be directed to the asset module or environment module to regenerate content in order to resolve the anomaly.

In some embodiments, the large language model (LLM) used to generate level creation instructions may be further trained or fine-tuned using debugging data. For example, the LLM may be trained to interpret structured debugging reports generated by the agent module, including information about gameplay failure cases, spatial context, and agent behavior logs. Based on this input, the LLM learns to generate corrective level creation instructions that address the identified issues while preserving intended gameplay flow and challenge level. This training enhances the LLM's ability to generate targeted and contextually appropriate fixes in response to anomalous gameplay scenarios.

In some embodiments, the sampling module may include an image analysis model trained to detect anomalies in gameplay visuals. The sampling module may periodically or continuously receive rendered video frames or graphical output generated during gameplay by the video game application. These frames may be analyzed using a machine learning model trained on gameplay data annotated with visual anomalies, such as blocked paths, unreachable zones, or irregular terrain structures. Upon detecting an anomaly, the sampling module may generate one or more level creation instructions to modify the corresponding region of the virtual interactive environment. These instructions may be routed to the asset module or environment module to address the identified issue. In some embodiments, the image analysis model may be used independently or in combination with agent-based validation feedback.

This architecture supports a broad range of adaptive and automated gameplay generation and validation workflows. It may be used during runtime, level prototyping, agent testing, or as part of a developer-in-the-loop design tool. The modular separation of prediction, instruction generation, asset placement, and topology modification enable flexible deployment across different development environments and gameplay contexts. In some embodiments, the game engine of a video game is configured for rendering and displaying the newly generated context among the virtual interactive environment during gameplay. For example, a game engine processes the data received from LCS modules to recreate a virtual interactive environment with one or more changes.

### LCS Process

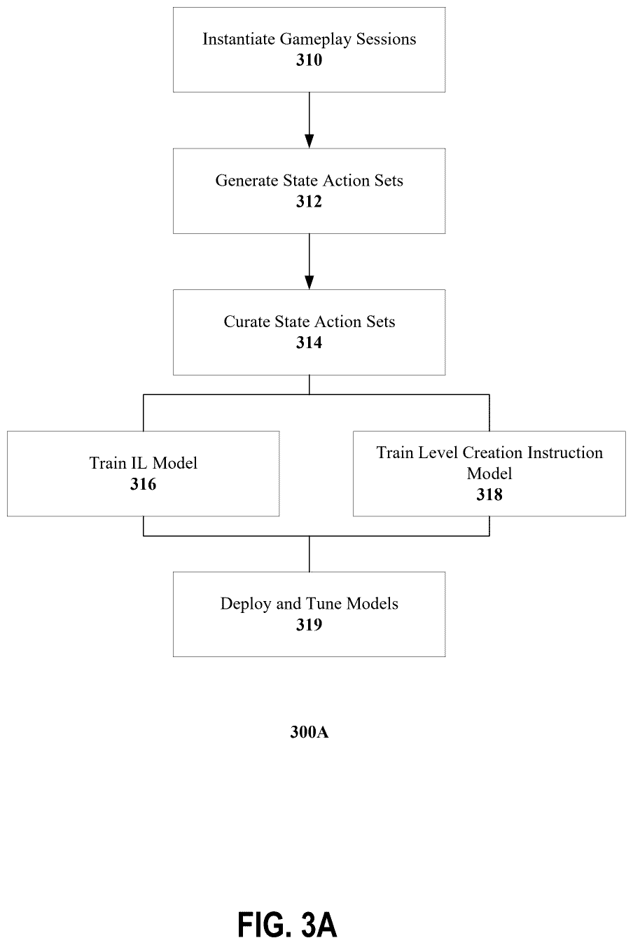

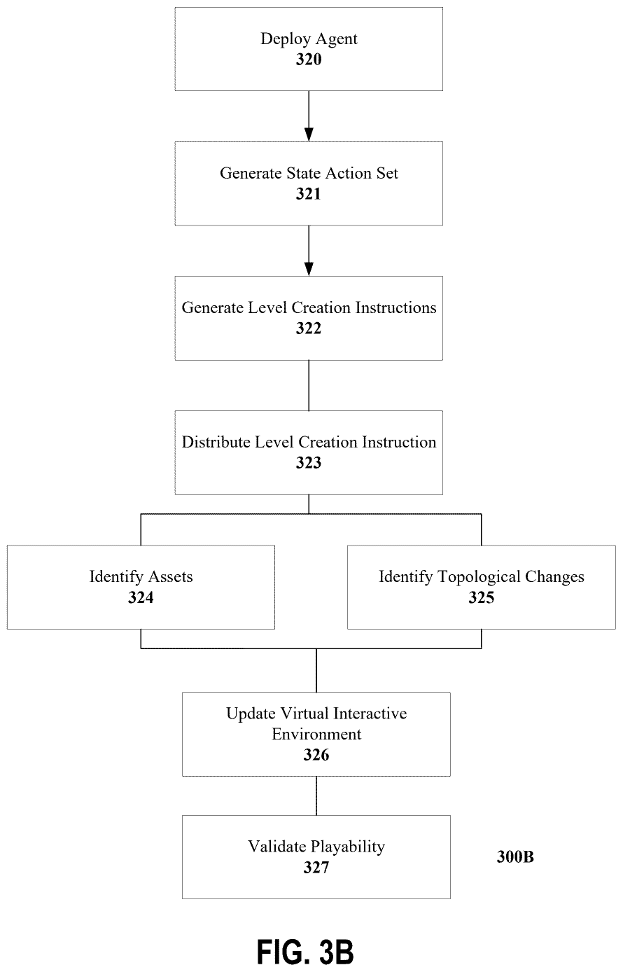

FIG. 3A illustrates an example process 300A for training one or more components of a Level Creation System (LCS), including an imitation learning (IL) agent configured to generate state action sets for gameplay-aware content and/or game level generation. In some embodiments, process 300A corresponds to video game application 130 and LCS 140 of FIG. 1B.

At step 310, the system executes or instantiates one or more gameplay sessions of a video game. These sessions may be controlled by human players, scripted virtual characters, or previously trained agents operating within one or more virtual interactive environments. During gameplay, the system captures gameplay data that includes state data, player actions, positional data, environment states, and any modifications to the level occurring as a result of gameplay behavior.

At step 312, the system generates structured state action sets from the captured gameplay data. Each state action set includes at least: (i) state data describing a current context within the game (e.g., the status of a character or the configuration of the surrounding environment) and (ii) a gameplay action taken from that state. These state action sets may correspond to a specific character, agent, or region of the virtual interactive environment.

At step 314, the system curates the state action sets into one or more memory buffers or datasets. These buffers may be used to construct training datasets for behavior modeling, scenario prediction, and instruction generation. In some embodiments, the system categorizes the data based on gameplay context, agent role, or environment type.

At step 316, one or more IL agents (e.g., IL models) are trained using the curated dataset of state action sets. The training objective may include predicting actions from states or learning policies that map gameplay states to expected future outcomes. In some embodiments, the training model uses supervised imitation learning, reinforcement learning, or hybrid techniques. In some embodiments, the training process includes reinforcement learning (RL), where agents autonomously interact with a simulation environment to improve their policy through exploration and reward feedback. This enables training to continue even without human-labeled data.

At step 318, a level creation instruction model of the sampling module (e.g., a large language model) are also trained based on captured gameplay data, state actions sets, scripted level design patterns, and level creation instructions, among other things. The LLM is trained to interpret state action sets and generate corresponding level creation instructions. For example, In role-playing games or narrative environments, fine-tuning may include natural language examples of dialogue-driven gameplay, with state action sets incorporating text-based state information and a corresponding real and/or example level creation instruction.

At step 319, the trained IL models and level creation instruction models (e.g., of an LCS) are deployed within a gameplay session for validation and/or fine tuning. In some embodiments, the training process may be repeated or extended over time using newly collected gameplay data, enabling recursive improvement. In some embodiments, gameplay data generated from future sessions is logged and added to the training dataset for iterative fine-tuning.

FIG. 3B illustrates an example process 300B for executing inference operations of a Level Creation System (LCS) to dynamically modify a game level based on predicted gameplay behavior. In some embodiments, process 300B corresponds to video game application 130 and LCS 140 of FIG. 1B.

At step 320, an IL agent is deployed into an active gameplay session for gameplay. In some embodiments, the agent is configured to observe the game state to understand the gameplay context. This context includes state data such as the agent's position, posture, equipment state, objectives, affordance, and/or other potential or available interactions with the environment. In other embodiments, where the gameplay agent is deployed into an empty gameplay level, a temporary or predefined context can be provided to the agent through an agent module.

At step 321, the agent generates a state action set during gameplay. The state action set represents a potential or likely gameplay behavior to be performed from the current state (e.g., state=crouching, action=vault_forward). The state action set may also reflect inferred environmental or strategic needs. For example, in an empty gameplay level, the agent can sequentially infer environmental changes by generating a sequence of state action sets.

At step 322, the state action set is transmitted to a sampling module to generate level creation instructions. For instance, the sampling module analyzes the state data and action data of the received state action set to determine what modifications or additions should be made to the virtual interactive environment. Based on this analysis, the module generates one or more level creation instructions. These instructions may include asset placements (e.g., enemy NPC, destructible wall) or topological modifications (e.g., ramp, ledge, trench).

At step 323, the level creation instructions are distributed to one or more downstream modules of the LCS for processing. If the instruction corresponds to asset placement, the instruction is sent to the asset module for processing. If the instruction corresponds to terrain or structural modification, it is sent to the environment module for processing.

At step 324, the asset module accesses a data store of game assets to identify and instantiate an asset based on the level creation instructions. The asset is placed within the virtual interactive environment at a defined location or offset, such as relative to the agent's current position. In some embodiments, the asset module is also configured to perform reskinning by (i) swapping out the selected asset with another of similar function but different thematic style, or (ii) replacing the texture applied to the asset based on a visual or gameplay theme. Reskinning instructions may be embedded within the level creation instructions.

At step 325, the environment module receives level creation instructions to identify one or more topological changes to make to the level or virtual environment of the game session. These changes may be applied by subdividing a mesh in the affected area, displacing vertices to form terrain features, and updating the corresponding collision mesh to reflect new physical boundaries. In some embodiments, the environment module also supports reskinning of terrain by modifying surface textures or material properties as instructed.

At step 326, the newly instantiated assets and topological changes are committed to the virtual interactive environment. In this way, the virtual interactive environment can be updated to reflect the new structure or content, enabling the predicted gameplay behavior of the generated state action pair to be performed. In some embodiments, the changes to the virtual interactive environment are not applied to the live instance of the virtual interactive environment during a respective gameplay session, such that the updated virtual interactive environment can be accessed in a subsequent gameplay session that instantiates an instance of the updated virtual interactive environment. In other embodiments, the changes to the virtual interactive environment are updated in, or during, the live—or respective—instance of the virtual interactive environment during gameplay and can be interacted with during the same gameplay session.

At step 327, the agent directed for gameplay among the updated environment for playability validation and/or verification. For example, an LCS can establish a task for agents to complete a path through the modified level to evaluate navigability of the new changes. If the environment is found unplayable, sampling module 243 may be re-engaged to regenerate instructions, or the agent module may produce an alternative state action set. For example, if the state action set leads to an invalid or unplayable scenario, the sampling module may revise the level creation instructions or re-query the agent for an alternative prediction, enabling recovery and adaptation during gameplay.

In some embodiments, the system also includes logic for fallback action selection. If the initially predicted action is no longer valid or the required environmental support cannot be satisfied, the system may select from alternative actions or generate a modified state aligned with the current context. This inference process may also operate on seeded or partially constructed levels, allowing the LCS to extend or complete a level design that was initially authored by a human or generated by a prior session.

The steps and processes of 300A and 300B can be associated with one or more hardware and/or software modules configured with computer-executable instructions. A person of ordinary skill in the art would recognize and appreciate how the proceeding process may be configured in many ways, such that one or more of steps are performed before, after, or simultaneously among other steps, and/or otherwise omitted or substituted in whole or in part.

### Example Level Creation

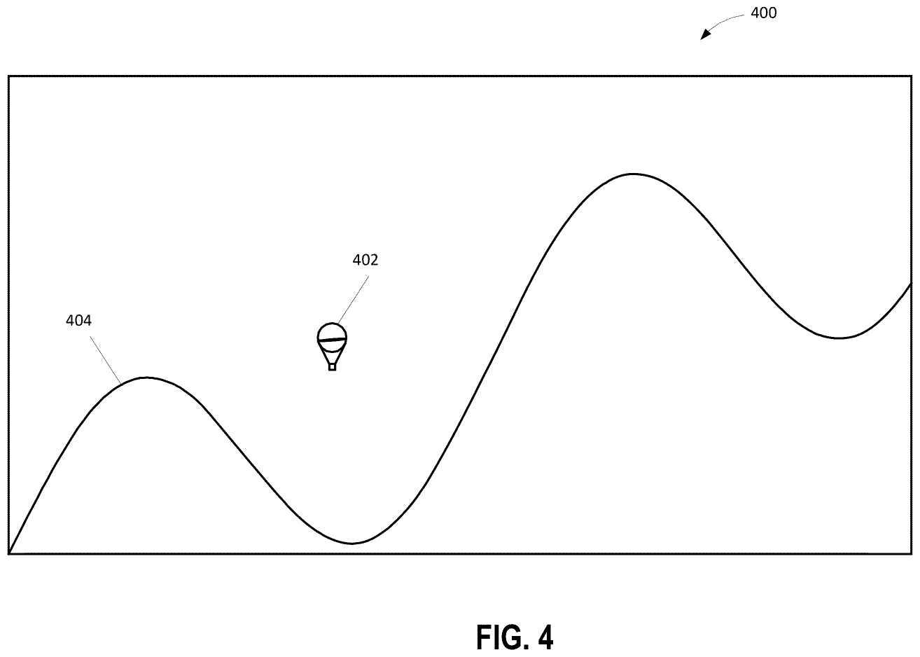

FIG. 4 illustrates an example embodiment of a gameplay scenario 400 used for training an imitation learning (IL) agent. The environment features a virtual character represented as a parachute 402 controlled by a player navigating through a series of curved terrain elevations 404, which may represent a stylized mountainous region.

The player interacts with the game via directional input (e.g., pressing “up” or “down” keys) to guide the parachute 402 through the undulating terrain. These inputs are recorded as part of a set of gameplay actions, while the resulting positional changes and environmental context are recorded as state data. Together, these are used to generate structured state action sets that capture how a player responds to particular spatial challenges.

The training process may use state action sets to model the agent's behavior, enabling the IL agent to learn context-aware action prediction. In some embodiments, the gameplay is used to train the IL model in real-time, while in other cases the data may be stored, processed offline, and used for imitation learning or reinforcement learning.

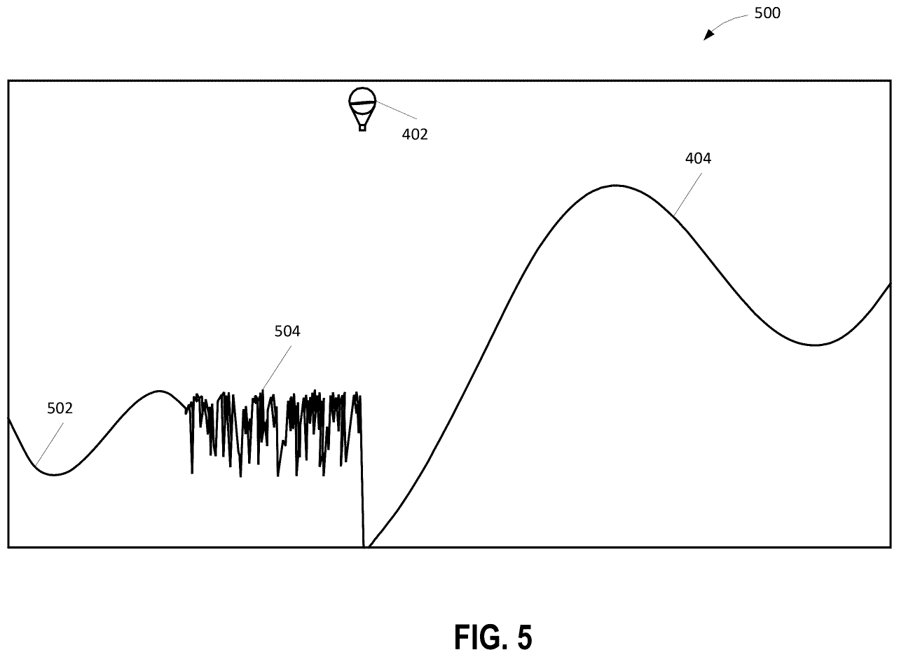

FIG. 5 illustrates an example embodiment of gameplay scenario 500, in which the IL agent trained in FIG. 4 has been deployed to infer gameplay behavior and direct dynamic level generation. As the parachute 402 progresses through the environment, the system generates a new segment of terrain at runtime based on the state action set generated by the agent.

However, as shown by element 504, this newly generated region includes an anomalous terrain formation. The anomaly may consist of an overly jagged or noisy segment that disrupts expected gameplay, such as erratic peaks or impassable spikes. This segment may have been generated due to either a misalignment between agent prediction and environmental context, or due to insufficient smoothing or sampling noise within the environment module's topology operations.

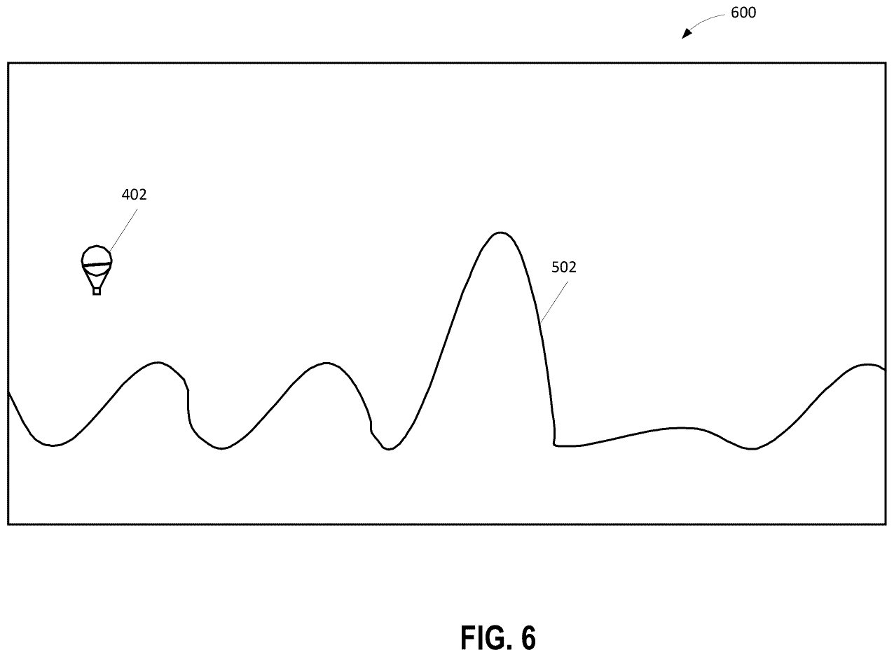

The terrain 502 remains as a supporting structure extending beyond the anomaly and is later reused and revised in FIG. 6. Additionally, while this example focuses on topological generation, in other embodiments, the LCS may also instantiate procedural assets—such as floating rings, collectible powerups, or wind obstacles—based on the predicted gameplay behavior. For instance, if the agent's predicted action was “collect,” the asset module could place a reward pickup above terrain 404; or if the action was “evade,” a wind tunnel element could be spawned midair to redirect the parachute's path.

FIG. 6 illustrates an example embodiment of a gameplay scenario 600 where the IL agent is used to validate playability and filter or correct anomalies in the previously generated game level. The terrain anomaly 504 from FIG. 5 is no longer present. Instead, a revised terrain segment 502 is shown, which retains the general spatial coverage of the original segment but has been procedurally corrected to remove the disruptive elements.

During this verification stage, the IL agent is used in a playtesting role to simulate navigation through the generated environment. As part of the Level Creation System (LCS), the system detects whether any generated terrain or placed assets violate playability constraints. These may include blocked paths, impossible jumps, collision traps, or other anomalies that would prevent successful progression.

Upon detecting that the region 504 was unplayable, the system regenerated the segment—either by rerunning the sampling module to generate a new state action set or by modifying the level creation instructions previously applied. The corrected segment 502 may have undergone mesh smoothing, adjusted vertex displacement, or terrain flattening to ensure that the parachute 402 can now navigate through it. In some embodiments, a reskinning instruction may also be applied to ensure that the corrected terrain is visually and thematically consistent with the rest of the level.

This process ensures that generated levels are not only responsive to gameplay predictions but also validated for semantic and functional coherence. In alternate embodiments, assets can also be re-evaluated for placement viability—e.g., ensuring that pickups are reachable, or enemy placements do not cause unavoidable damage.

### Computing Device

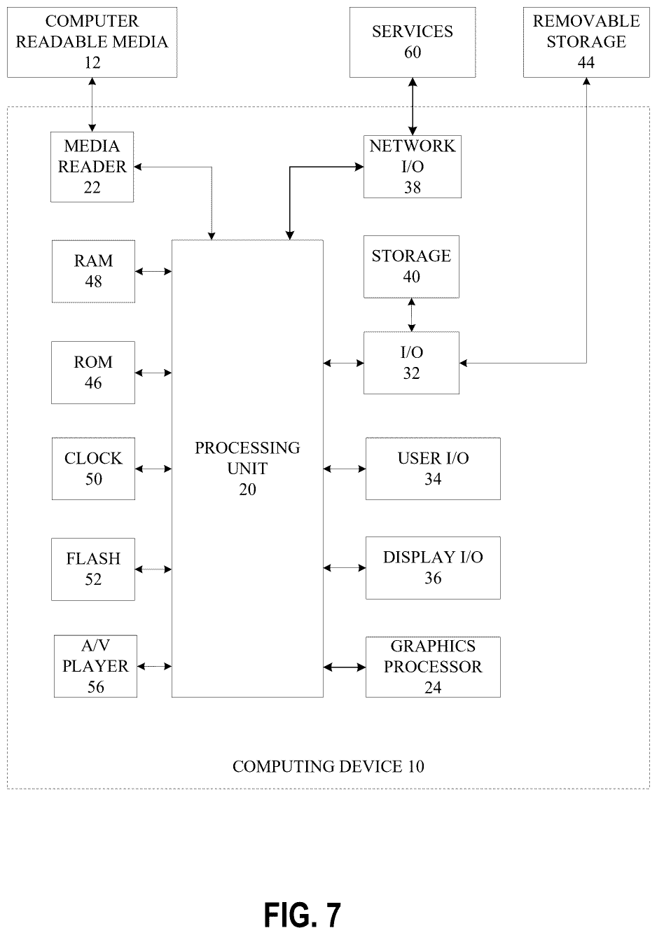

FIG. 7 illustrates an example embodiment of a computing device 10. In some embodiments, some or all of the aforementioned systems and computing devices—such as computing devices of 104 and 106 of FIG. 1—are similar to computing device 10. The example computing device 10 can store and/or execute computer executable instructions (or code) of applications (or programs or software), such as video game applications, interactive applications, and/or other applications known to those of skill in the art that could include or benefit from the systems and methods described herein.

Computing device 10 can be or include any one or a combination of systems known to those of skill in the art, including, for example, a desktop, laptop, game application platform, game console, virtual reality system, augmented reality system, television set-top box, television, network-enabled kiosk, car-console devices, computerized appliance, wearable device (e.g., smart watch, glasses with computing functionality), and wireless mobile devices (e.g., smart phones, PDAs, tablets) and other general-purpose computing devices known to those of skill in the art.

As shown, computing device 10 includes processing unit 20 that interacts with other components of the computing device 10 and external components. A media reader 22 communicates with computer readable media 12. The media reader 22 may be an optical disc reader capable of reading optical discs, such as DVDs or Blu Ray discs, or any other type of reader that can receive and read data from computer readable media 12. One or more of the computing devices may be used to implement one or more of the systems disclosed herein.

Computing device 10 may include a graphics processor 24. In some embodiments, the graphics processor 24 is integrated into the processing unit 20, such that the graphics processor 24 may share Random Access Memory (RAM) with the processing unit 20. Alternatively, or in addition, the computing device 10 may include a discrete graphics processor 24 that is separate from the processing unit 20. In some such cases, the graphics processor 24 may have separate RAM from the processing unit 20. Computing device 10 might be a video game console device, a general-purpose laptop or desktop computer, a smart phone, a tablet, a server, or other suitable system for executing software among graphics processor 24, such as a video game application.

Computing device 10 also includes various components for enabling input/output, such as an I/O 32, a user I/O 34, a display I/O 36, and a network I/O 38. I/O 32 interacts with storage element 40 and removable storage media 44 to provide storage for computing device 10. Processing unit 20 can communicate through I/O 32 to store data. In addition to storage 40 and removable storage media 44, computing device 10 is also shown including ROM (Read-Only Memory) 46 and RAM 48. RAM 48 may be used for data that is accessed frequently during execution of software.

User I/O 34 is used to send and receive commands between processing unit 20 and user devices, such as keyboards or game controllers. In some embodiments, the user I/O can include a touchscreen. The touchscreen can be a capacitive touchscreen, a resistive touchscreen, or other type of touchscreen technology that is configured to receive user input through tactile inputs from the user. Display I/O 36 provides input/output functions that are used to display images. Network I/O 38 is used for input/output functions for a network (e.g., receiving and sending network data communications). Network I/O 38 may be used during execution of software applications by computing device 10; such as when a video game application communicates with a game server over a network.

Display output signals produced by processing unit 20 and/or graphics processor 24 can be sent to display by display I/O 36, including signals for displaying visual content produced by computing device 10; such as display output rendered by a video game application, including graphics, GUIs, video, and/or other visual content. Computing device 10 may comprise one or more integrated displays configured to receive display output signals produced by display I/O 36. According to some embodiments, display output signals produced by display I/O 36 may also be output to one or more display devices external to computing device 10, such a display 16.

The computing device 10 can also include other features, such as a clock 50, flash memory 52, and other components. An audio/video player 56 might also be used to play a video sequence, such as a movie or other media as known to those of ordinary skill in the art. An audio/video player 56 may include or use software for encoding or decoding media for playback.

Computer executable instructions, applications, programs, or code (e.g., software) can be stored in ROM 46, RAM 48, media 12, and/or storage 40 (which might comprise hard disk, other magnetic storage, optical storage, other non-volatile storage or a combination or variation of these). Part of the program code can be stored in ROM that is programmable (ROM, PROM, EPROM, EEPROM, and so forth), part of the program code can be stored in storage 40, and/or on removable media such as media 12 (which can be a CD-ROM, cartridge, memory chip or the like, or obtained over a network or other electronic channel as needed). In general, applications can be found embodied in a tangible non-transitory signal-bearing medium.

Random access memory (RAM) 48 (and possibly other storage) is usable to store variables and other processor data as needed. RAM is used and holds data that is generated during the execution of an application and portions thereof might also be reserved for frame buffers, application state information, and/or other data needed or usable for interpreting user input and generating display outputs. Generally, RAM 48 is volatile storage and data stored within RAM 48 may be lost when the computing device 10 is turned off or loses power.

As computing device 10 reads media 12 and provides an application, information may be read from media 12 and stored in a memory device, such as RAM 48. Additionally, data from storage 40, ROM 46, services 60 accessed via a network (not shown), or removable storage media 46 may be read and loaded into RAM 48. Although data is described as being found in RAM 48, it will be understood that data does not have to be stored in RAM 48 and may be stored in other memory accessible to processing unit 20 or distributed among several media, such as media 12 and storage 40.

The disclosed subject matter can include an apparatus for performing the operations herein. This apparatus may be specially constructed for the required purposes, or it may comprise a general-purpose computer selectively activated or reconfigured by an application stored and/or executed by computing device 10. Such an application may be stored in a non-transitory computer readable medium, such as, but not limited to, any type of disk including optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The disclosed subject matter may include a non-transitory computer readable medium having stored thereon applications or instructions, which may be used (e.g., executed) to instruct a system or computing devices to perform a process according to the disclosed subject matter. A non-transitory computer readable medium includes any mechanism for storing or transmitting information in a form readable by a computing device and other systems of the like known to those of skill in the art.

The applications or instructions of computing device 10 can be stored and/or executed among a local environment and/or among in a distributed environment of computing devices, as known to those of skill in the art. Different applications can include varying instructions, components, graphical configurations, and/or data for supporting their runtime execution on different hardware (e.g., different types of computing devices).

A locally executed application does not rely on or use an external computing device (e.g., a system other than computing device 10) to execute the application. In some instances, a locally executable video game application can communicate with external systems or devices, such as external servers, to retrieve information associated with the video game, such as game patches, game authentication, cloud saves, user account data, previously trained model data, or other features.

In distributed implementations, computing device 10 may execute portions of a video game application, while other systems or devices such as external servers execute other portions of the video game application. For instance, massively multiplayer online role-playing games (MMORPGs) include client portions (e.g., video game application) of the video game executed by computing devices of or corresponding to users or players, and server portions executed by one or more servers. It should be understood that applications described herein can be a locally executable game or a distributed application.

Graphics processor 24, or graphics processing unit (GPU), can perform processing tasks associated with rendering images, graphics, and visual content, in addition to machine learning tasks. A GPU commonly comprises multiple processing cores that execute operations in parallel, optimizing performance for tasks such as 3D rendering, texture mapping, shading, and real-time physics simulations. In addition to dedicated rasterization units, shading engines, and ray-tracing cores, a GPU may include high-bandwidth memory (VRAM) and support for general-purpose computing, enabling it to handle computational workloads beyond graphics, including scientific simulations, cryptography, and machine learning and/or neural network processing. GPUs can operate as discrete hardware components or as integrated units within system-on-chip (SoC) architectures, often interfacing with CPUs, memory controllers, and high-speed interconnects for efficient data processing.

As known to a person of ordinary skill in the art, modern GPUs increasingly incorporate dedicated machine learning hardware, such as tensor cores, matrix multiplication units, and neural processing units (NPUs), which accelerate deep learning inference, neural network training, and AI-driven rendering techniques. These specialized components enhance real-time upscaling, denoising, adaptive shading, as well as neural-based image, frame, video, and audio reconstruction, among other things, allowing for more efficient and high-fidelity visual output. Accordingly, it is appreciated that GPUs can be configured to enable the execution of neural rendering models, physics-based simulations, and real-time generative AI applications, in addition to the systems and methods described herein.

The present disclosure may use machine learning. Machine learning is a subfield of artificial intelligence, which, to persons of ordinary skill of the art, corresponds to underlying algorithms and/or frameworks (commonly known as “neural networks” or “machine learning models”) that are configured and/or trained to perform and/or automate one or more tasks or computing processes. For simplicity, the terms “neural networks” and “machine learning models” can be used interchangeably and can be referred to as either “networks” or “models” in short.

The present disclosure may use deep learning. Deep learning is a subfield of artificial intelligence and machine learning, which, to persons of ordinary skill of the art, corresponds to multilayered implementations of machine learning (commonly known as “deep neural networks”). For simplicity, the terms “machine learning” and “deep learning” can be used interchangeably.

As known to a person of ordinary skill in the art, machine learning is commonly utilized for performing and/or automating one or more tasks such as identification, classification, determination, adaptation, grouping, and generation, among other things. Common types (e.g., classes or techniques) of machine learning include supervised, unsupervised, regression, classification, reinforcement, and clustering, among others.

Among these machine learning types are a number of model implementations, such as linear regression, logistic regression, evolution strategies (ES), convolutional neural networks (CNN), deconvolutional neural networks (DNN), generative adversarial networks (GAN), recurrent neural networks (RNN), mixture-of-experts (MoE), transformers, support vector machines (SVM), Bayesian networks, k-nearest neighbors (KNN), decision trees, gradient boosting machines (GBM), autoencoders, long short-term memory networks (LSTM), reinforcement learning models (RL), imitation learning models (IL), and random forest, among others. As known to a person of ordinary skill in the art, one or more machine learning models can be configured and trained for performing one or more tasks during runtime of a machine learning module.

As known to a person of ordinary skill in the art, the output of a machine learning model is based at least in part on its type, implementation, configuration, and/or training data. The data that models are trained on (e.g., training data) can include one or more data types. In some embodiments, the training data of a model can be changed, updated, and/or supplemented throughout training and/or inference (i.e., runtime) of the model.

The systems, methods, and/or computing devices of the present disclosure can include machine learning modules. A “machine learning module” is a software module and/or hardware module including computer-executable instructions to configure, train, and/or deploy (e.g., execute) one or more machine learning models.

Some aspects of the present disclosure include subject matter corresponding to the gameplay of video game applications. As known to a person of ordinary skill in the art, the gameplay of a video game is commonly known as occurring among a game session within one or more instances of one or more virtual interactive environments. The gameplay of a video game provides interactivity with one or more aspects of a video game.

A game session may include a number of player characters and/or non-player characters. As known to those of skill in the art, player characters are character models that can be controlled or directed (at least primarily) by users or players through inputs at their respective computing devices and can perform gameplay actions or commands. “Non-player characters” (also referred to herein as “NPCs”) are characters that are not or cannot be controlled and/or directed (primarily by users or players). Rather, NPCs can be configured with computer executable instructions to perform one or more gameplay tasks and/or actions, with and/or without the need for input or interaction from a user/player or player character.

A game session may include a number of player objects. Player objects can refer to controllable objects, or models, used to facilitate or enable gameplay or other in-game actions. Player objects may be, for example, vehicles, vessels, aircraft, ships, tiles, cards, dice, pawns, and other in-game items of the like known to those of skill in the art. In some embodiments, a user or player can control or direct one or more player objects in a game session, including, in some instances, by controlling player characters which in turn cause the objects to be controlled.

For simplicity, player characters and player objects disclosed are collectively referred to herein as player characters in some embodiments. It should be understood that, as used herein, “controllable” refers to the characteristic of being able and/or configured to be controlled and/or directed (e.g., moved, modified, etc.) by a player or user through one or more input means, such as a controller or other input device, by a player or user. As known to a person of ordinary skill in the art, player characters include character models configured to receive input.

Some aspects of the present disclosure include subject matter corresponding to data of video game applications. As known to a person of ordinary skill in the art, data of a video game application can include data such as state data, simulation data, rendering data, digital assets, and other data of the like.

State data is commonly known as data describing a state of a player character, virtual interactive environment, and/or other virtual objects, actors, or entities—in whole or in part—at one or more instances or periods of time during a game session of a video game. For example, state data can include the current location and condition of one or more player characters among a virtual interactive environment at a given time, frame, or duration of time or number of frames.

State data can be simulated and/or generated by a simulator of a video game engine to produce simulation data. Simulation data, or state simulation data, is commonly known as the underlying data corresponding to the simulated aspects (e.g., physics and other corresponding mechanics) to drive simulation of a model or object in a game engine. For example, simulation data can include the joint and structural configuration of a character model and corresponding physical forces or characteristics applied to it at instance or period of time during gameplay, such as a “frame”, to create animations, among other things. Accordingly, simulation data can correspond to the positioning, movements, and/or animation of objects and/or characters in a video game.

Render Data is commonly known as the underlying data corresponding to rendering (e.g., visual, and auditory rendering) aspects of a game session, which are rendered (e.g., for output to an output device) by a game engine. For example, render data can include data corresponding to the rendering of graphical, visual, auditory, and/or haptic output of a video game, among other things.

Game assets (or assets in short) can include virtual objects, character models, actors, entities, geometric meshes, textures, terrain maps, animation files, audio files, digital media files, font libraries, visual effects, and other digital assets of the like commonly used in video games.

In some embodiments, a game session or gameplay is based in part on the data of a video game. One or more aspects of gameplay (e.g., rendering, simulation, state, gameplay actions of player characters) uses, produces, generates, and/or modifies game data. Likewise, gameplay events, objectives, triggers, and other aspects, objects, or elements of the like also use, produce, generate, and/or modify data of a video game.

The data of a video game may be updated, versioned, and/or stored periodically as a number of files to a computing device. Additionally, game data, or copies and/or portions thereof, can be stored, referenced, categorized, or placed into a number of buffers or storage buffers. A buffer can be configured to capture particular data, or data types, of game data for processing and/or storage.

Some aspects of the present disclosure include subject matter corresponding to video games, including video game components corresponding to the software of a video game. As known to a person of ordinary skill in the art, game code is software defining the gameplay, features, and aspects of a video game whereas a game engine provides underlying frameworks and software that support and facilitate execution of the game code (e.g., gameplay)

As a non-limiting descriptive example, a game engine includes, among other things, a renderer, simulator, and stream layer. A game engine uses game data (e.g., state data, render data, simulation data, audio data, and other data types of the like) to generate and/or render one or more outputs (e.g., visual output, audio output, and haptic output) for one or more computing devices. In some embodiments, a game engine is a distributable computer executable runtime portion of development software, such as a video game development engine.

A renderer is a graphics framework that manages the production of graphics corresponding to lighting, shadows, textures, user interfaces, and other effects to game assets of the like among a game engine. A simulator refers to a framework that manages simulation aspects corresponding to physics and other corresponding mechanics used in part for animations and/or interactions of gameplay objects, entities, characters, lighting, gases, and other game assets or effects of the like. A stream layer is a software layer that allows a renderer and simulator to execute independently of one another among a game engine by providing a common execution stream for renderings and simulations to be produced and/or synchronized (e.g., scheduled) at and/or during runtime.

A game engine also includes an audio engine or audio renderer that produces and synchronizes audio playback with or among the common execution of a stream layer. For example, an audio engine of a game engine can use game data to produce audio output and/or haptic output from game data.

As used herein in some embodiments, video game applications can also use and/or include Software Development Kits (SDKs), Application Program Interfaces (APIs), Dynamically Linked Libraries (DLLs), and other software libraries, components, modules, shims, or plugins that provide and/or enable a variety of functionality; such as—but not limited to—graphics, audio, font, or communication support, establishing and maintaining service connections, performing authorizations, and providing anti-cheat and anti-fraud monitoring and detection, among other things.

Some portions of the detailed descriptions above are presented in terms of symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated (e.g., among a computing device). It has proven convenient at times, principally for reasons of common usage, to refer to these signals as bits, values, elements, symbols, characters, terms, numbers, or the like.

Certain example embodiments are described above to provide an overall understanding of the principles of the structure, function, manufacture and use of the devices, systems, and methods described herein. One or more examples of these embodiments are illustrated in the accompanying drawings. Those skilled in the art will understand that the descriptions herein and the accompanying drawings are intended to be illustrative, and not restrictive. Many other implementations will be apparent to those of skill in the art based upon the above description. Such modifications and variations are intended to be included within the scope of the present disclosure. The scope of the present disclosure should, therefore, be considered with reference to the claims, along with the full scope of equivalents to which such claims are entitled. The features illustrated or described in connection with one exemplary embodiment may be combined with the features of other embodiments. In some instances, well-known structures and devices are shown in block diagram form, rather than in detail, in order to avoid obscuring the disclosed subject matter.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A system comprising:
one or more processors; and
one or more memory devices, each of the one or more memory devices communicatively coupled to at least one of the one or more processors, the one or more memory devices storing computer-executable instructions that when executed cause the one or more processors to:
deploy an imitation learning agent into a gameplay session of a video game, the gameplay session comprising a virtual interactive environment for gameplay;
receive, based on gameplay by the imitation learning agent, a state action set generated by the imitation learning agent, the state action set comprising at least state data and a gameplay action;
determine, based at least in part on the state action set, one or more level creation instructions corresponding to at least one of: an asset placement or a topological modification;
identify one or more assets based on the one or more level creation instructions;
instantiate the one or more assets into the virtual interactive environment;
identify, based at least in part on the one or more level creation instructions, a portion of a topological surface of the virtual interactive environment for modification; and
modifying the identified portion of the topological surface based on the one or more level creation instructions.

2. The system of claim 1, wherein the deployed agent is a trained imitation learning model, and wherein the computer-executable instructions further cause the one or more processors to:
receive game data comprising a plurality of state action sets, each state action set including a gameplay action and a corresponding game state;
curate the plurality of state action sets into one or more training datasets;
train the imitation learning model based at least in part on the one or more training datasets to predict gameplay actions from game states; and
update the imitation learning model using additional game data generated during one or more subsequent gameplay sessions.

3. The system of claim 1, wherein the level creation instructions are generated by a large language model, and wherein the computer-executable instructions further cause the one or more processors to:
receive historical game data comprising prior state action sets and corresponding level creation instructions;
curate the historical game data into a fine-tuning dataset;
train the large language model using the fine-tuning dataset to map state action sets to corresponding level creation instructions; and
deploy the trained large language model to generate level creation instructions based at least in part on predicted state action sets.

4. The system of claim 1, wherein each level creation instruction comprises:
a directive corresponding to one of an asset placement or a topological modification; and
a location within the virtual interactive environment at which the directive is to be applied.

5. The system of claim 1, wherein each level creation instruction includes data of at least one of the following data types:
natural language text; or
structured machine-readable data comprising key-value pairs or a structured data object.

6. The system of claim 1, wherein the state action set comprises:
state data representing a future state of a virtual character in the virtual interactive environment; and
a gameplay action associated with the future state.

7. The system of claim 1, wherein the state action set defines a gameplay scenario that has not yet occurred during gameplay.

8. The system of claim 1, for validating the updated virtual interactive environment, wherein the computer-executable instructions further cause the one or more processors to:
direct the imitation learning agent to simulate traversal through the updated virtual interactive environment;
identify one or more anomalies based on the simulated traversal, the anomalies comprising at least an incompletable task; and
regenerate one or more level creation instructions to modify the virtual interactive environment in response to the identified anomalies.

9. A computer implemented method to generate game level content by:
deploying an imitation learning agent into a gameplay session of a video game, the game session comprising a virtual interactive environment for gameplay;
receiving, based on gameplay by the imitation learning agent, a state action set generated by the imitation learning agent, the state action set comprising at least state data and a gameplay action;
determining, based at least in part on the state action set, one or more level creation instructions corresponding to at least one of: an asset placement or a topological modification;
identifying one or more assets based on the one or more level creation instructions;
instantiating the one or more assets into the virtual interactive environment of the video game;
identifying, based at least in part on the one or more level creation instructions, a portion of a topological surface of the virtual interactive environment for modification; and
modifying the identified portion of the topological surface based on the one or more level creation instructions.

10. The computer implemented method of claim 9, wherein the deployed agent is a trained imitation learning model, and wherein the computer-executable instructions further cause the one or more processors to:
receive game data comprising a plurality of state action sets, each state action set including a gameplay action and a corresponding game state;
curate the plurality of state action sets into one or more training datasets;
train the imitation learning model based at least in part on the one or more training datasets to predict gameplay actions from game states; and
update the imitation learning model using additional game data generated during one or more subsequent gameplay sessions.

11. The computer implemented method of claim 9, wherein the level creation instructions are generated by a large language model, and wherein the computer-executable instructions further cause the one or more processors to:
receive historical game data comprising prior state action sets and corresponding level creation instructions;
curate the historical game data into a fine-tuning dataset;
train the large language model using the fine-tuning dataset to map state action sets to corresponding level creation instructions; and
deploy the trained large language model to generate level creation instructions based at least in part on predicted state action sets.

12. The computer implemented method of claim 9, wherein each level creation instruction comprises:
a directive corresponding to one of an asset placement or a topological modification; and
a location within the virtual interactive environment at which the directive is to be applied.

13. The computer implemented method of claim 9, wherein each level creation instruction includes data of at least one of the following data types:
natural language text; or
structured machine-readable data comprising key-value pairs or a structured data object.

14. The computer implemented method of claim 9, wherein the state action set comprises:
state data representing a future state of a virtual character in the virtual interactive environment; and
a gameplay action associated with the future state.

15. The computer implemented method of claim 9, wherein the state action set defines a gameplay scenario that has not yet occurred during gameplay.

16. The computer implemented method of claim 9, for validating the updated virtual interactive environment, wherein the computer-executable instructions further cause the one or more processors to:
direct the imitation learning agent to simulate traversal through the updated virtual interactive environment;
identify one or more anomalies based on the simulated traversal, the anomalies comprising at least an incompletable task; and
regenerate one or more level creation instructions to modify the virtual interactive environment in response to the identified anomalies.

17. A non-transitory computer readable medium including computer executable instruction configured to generate game level content by:
deploying an imitation learning agent into a gameplay session of a video game, the game session comprising a virtual interactive environment for gameplay;
receiving, based on gameplay by the imitation learning agent, a state action set generated by the imitation learning agent, the state action set comprising at least state data and a gameplay action;
determining, based at least in part on the state action set, one or more level creation instructions corresponding to at least one of: an asset placement or a topological modification;
identifying one or more assets based on the one or more level creation instructions;
instantiating the one or more assets into the virtual interactive environment;
identifying, based at least in part on the one or more level creation instructions, a portion of a topological surface of the virtual interactive environment for modification; and
modifying the identified portion of the topological surface based on the one or more level creation instructions.

18. The non-transitory computer readable medium of claim 17, wherein the deployed agent is a trained imitation learning model, and wherein the computer-executable instructions further cause the one or more processors to:
receive game data comprising a plurality of state action sets, each state action set including a gameplay action and a corresponding game state;
curate the plurality of state action sets into one or more training datasets;
train the imitation learning model based at least in part on the one or more training datasets to predict gameplay actions from game states; and
update the imitation learning model using additional game data generated during one or more subsequent gameplay sessions.

19. The non-transitory computer readable medium of claim 17, wherein the level creation instructions are generated by a large language model, and wherein the computer-executable instructions further cause the one or more processors to:
receive historical game data comprising prior state action sets and corresponding level creation instructions;
curate the historical game data into a fine-tuning dataset;
train the large language model using the fine-tuning dataset to map state action sets to corresponding level creation instructions; and
deploy the trained large language model to generate level creation instructions based at least in part on predicted state action sets.

20. The non-transitory computer readable medium of claim 17, wherein each level creation instruction comprises:
a directive corresponding to one of an asset placement or a topological modification; and
a location within the virtual interactive environment at which the directive is to be applied.
